(19) United States
(12) Patent Application Publication
(10) Pub. No.: US 2020/0369869 A1
(43) Pub. Date: Nov. 26, 2020

(54) ERASER

(71) Applicant: SAKURA COLOR PRODUCTS CORPORATION, Osaka-shi, Osaka (JP)

(72) Inventors: Shinji TSUJIO, Osaka-shi (JP); Hiroyoshi YAMAMOTO, Osaka-shi (JP); Nobuaki KOBAYASHI, Osaka-shi (JP); Takayuki KITAGUCHI, Osaka-shi (JP)

(73) Assignee: SAKURA COLOR PRODUCTS CORPORATION, Osaka-shi, Osaka (JP)

(21) Appl. No.: 16/766,316

(22) PCT Filed: Dec. 11, 2018
(86) PCT No.: PCT/JP2018/045452

§ 371 Date: May 22, 2020

(30) Foreign Application Priority Data
Dec. 12, 2017 (JP) 2017-238081

(51) Int. Cl. C08L 61/28; B43L 19/00; C08L 27/06; C08K 5/11; C08K 3/013; C08K 3/014; C08K 3/26; C08K 3/32; C08J 9/42; C08J 9/40; C08K 3/105

(52) U.S. Cl. CPC C08L 61/28; B43L 19/0025; C08L 27/06; C08K 5/11; C08K 3/013; C08K 3/014; C08J 2361/28; C08K 3/32; C08J 9/42; C08J 9/405; C08K 3/105; C08K 2003/265; C08K 3/26

(57) ABSTRACT

An eraser includes: a base material including a plasticizer and at least one of a resin component or an elastomer component; and a porous foam made of a resin and impregnated with the resin base material, and the plasticizer has an SP value of 8.3 or more and 10 or less.

### TECHNICAL FIELD

The present invention relates to an eraser. This application claims priority to Japanese Patent Application No. 2017-238081, which was filed on Dec. 12, 2017, and is incorporated herein by reference in its entirety.

### BACKGROUND ART

So-called erasers have been widely used. A typical eraser is produced by uniformly mixing a base resin such as a vinyl chloride resin with a plasticizer, a filler, and when necessary, a colorant, for example, and then by molding the mixture with heat. Patent Literature 1 discloses an example of such an eraser.

### CITATION LIST

### Patent Literature

Patent Literature 1: Japanese Patent Application Laid-Open No. S55-34990

### SUMMARY OF INVENTION

### Technical Problem

An eraser preferably has high erasability, that is, high capacity of erasing characters and marks. The eraser is required to have sufficient elasticity and can withstand gripping for easy erasing. That is, the eraser preferably has both high elasticity and high erasability.

It is therefore an object of the present invention to provide an eraser having both high elasticity and high erasability.

### Solution to Problems

An eraser according to the present invention includes: a base material including a plasticizer and at least one of a resin component or an elastomer component; and a porous foam made of a resin and impregnated with the base material. The plasticizer has an SP value of 8.3 or more and 10 or less.

The eraser has a structure in which the resin porous foam is impregnated with the base material. Since the plasticizer has an SP value of 8.3 or more and 10 or less, the plasticizer is compatible with the resin component and elastomer, and is capable of maintaining a relatively high elasticity while expressing necessary functions as an eraser. Thus, such an eraser has both high elasticity and high erasability. The plasticizer preferably has an SP value of 8.5 or more and 9.8 or less.

In the eraser, the porous foam is preferably a melamine foam. The melamine foam is fragile to friction, has an appropriate tensile strength, and has high affinity for the base material. Thus, the melamine foam is especially preferable as a material for obtaining an eraser having both high shape retention and high erasability.

The plasticizer preferably includes at least one of ATBC or DOA. Both of ATBC and DOA are compounds including no phthalic acid in their molecular. Thus, ATBC and DOA are suitable in terms of safety of the eraser.

In the eraser, the base material may include a polyvinyl chloride resin as the resin component, a plasticizer, a filler, and a stabilizer, and the plasticizer may consist of ATBC. With this composition, a polyvinyl chloride having high versatility is employed as the resin component and the plasticizer is used as a single material so that an eraser can be produced at lower costs in consideration of safety.

In the eraser, the base material may include a polyvinyl chloride resin as a resin component, the plasticizer, a filler, and a stabilizer, and the plasticizer may consist of DOA. With this composition, polyvinyl chloride having high versatility is employed as the resin component and the plasticizer is used as a single material so that an eraser can be produced at lower costs in consideration of safety.

In the eraser, a content of at least one of the resin component or the elastomer component is 25.0% by mass or more and 45.0% by mass or less, and a content of the plasticizer may be 35.0% by mass or more and less than 55.0% by mass. With this composition, it is possible to ensure production of an eraser having both high elasticity and high erasability.

In the eraser, the porous foam has a tensile elasticity of preferably 0.03 MPa or more and 0.8 MPa or less, and more preferably 0.05 MPa or more and 0.4 MPa or less. By setting the tensile elasticity of the porous foam within the range described above, flexibility and shape retention of the eraser can be appropriately maintained.

In the eraser, the porous foam preferably has a density of 3.5 kg/m³ or more and 12.0 kg/m³ or less. By setting the density of the porous foam within the range described above, a preferable form can be made in production and application.

### Effects of the Invention

The eraser described above has a structure in which the resin porous foam is impregnated with the base material. Here, since the SP value of the plasticizer is 8.3 or more and 10 or less, the base material can be appropriately disposed in gaps in the porous foam so that a relatively high elasticity can be maintained. In addition, in the eraser described above, a part of the porous foam and the base material are appropriately removed when erasing, and thus, high erasability can be obtained. The eraser described above has both high elasticity and high erasability.

### BRIEF DESCRIPTION OF DRAWINGS

FIG. 1 is a perspective view illustrating an appearance of an eraser according to one embodiment of the present invention.

FIG. 2 is an enlarged cross-sectional view illustrating a part of the eraser illustrated in FIG. 1.

### DESCRIPTION OF EMBODIMENTS

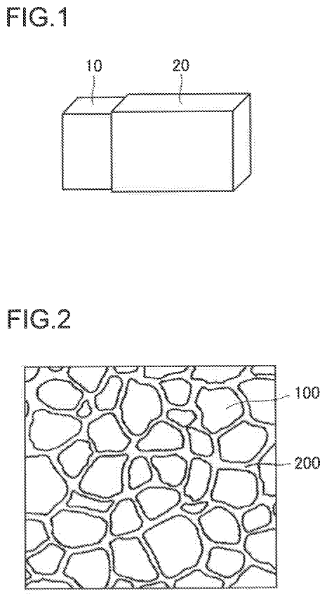

An embodiment of the present invention will be described hereinafter. FIG. 1 is a perspective view illustrating an appearance of an eraser according to one embodiment of the present invention. FIG. 2 is an enlarged cross-sectional view illustrating a part of the eraser illustrated in FIG. 1. A structure of an eraser according to one embodiment of the present invention will be described with reference to FIGS. 1 and 2 as necessary.

An eraser 10 is partially exposed for erasing characters and marks, and the other portion of the eraser 10 is covered with a cover 20 made of, for example, paper in order to prevent stain. When the exposed portion of the eraser 10 wears down by erasing, the cover 20 is partially discarded so that a new portion of the eraser 10 is exposed for erasing. The eraser 10 has a structure in which gaps in a porous foam 200 are impregnated with a base material 100.

[Base Material]

The eraser 10 includes a base material 100 including a plasticizer and at least one of a resin component or an elastomer component.

Although not specifically limited, examples of a resin constituting the resin component include various resins such as a thermoplastic resin, a thermosetting resin, an ultraviolet curing resin, an electron beam curing resin, a multiple-liquid curing resin exemplified by a two-liquid curing resin, a catalyst curing resin, and cellulose ester. Among these resins, the thermoplastic resin is preferably used. Such resins can be used in the form of being dissolved in a solvent, being dispersed in a solvent, or being emulsified.

More preferable examples of the resin specifically include vinyl chloride-based resins such as polyvinyl chloride, vinyl chloride-vinyl acetate-based resin, and vinyl chloride-ethylene-vinyl acetate-based resin, and vinyl acetate-based resins such as ethylene-vinyl acetate resin. Among these resins, the vinyl chloride-based resin, especially polyvinyl chloride, is preferable because such resins are easily mixed with the plasticizer and preferably used for obtaining an eraser having high erasability.

Examples of the elastomer component include polyisoprene (natural rubber), a styrene-based elastomer, a butadiene-based elastomer, an isoprene-based elastomer, an ethylene-propylene-based elastomer, a nitrile-based elastomer, a chloroprene-based elastomer, a urethane-based elastomer, an acrylic-based elastomer, a polyester-based elastomer, and an olefin-based elastomer.

These resin components and elastomer components may be used singly or two or more of these components may be used in combination as necessary.

The plasticizer can be appropriately selected depending on, for example, a thermoplastic resin used. As the plasticizer, a plasticizer having a solubility parameter (SP) value (solubility parameter) of 8.3 or more and 10 or less is selected. If the SP value is smaller than 8.3 or larger than 10, compatibility with the resin component and a component constituting the elastomer generally decreases, and eventually shows insufficient function as the eraser 10. The plasticizer preferably has an SP value of 8.5 or more and 9.8 or less.

Examples of the plasticizer include: phthalate-based plasticizers such as phthalic acid bis(2-ethylhexyl) (DOP) (SP value: 8.9), diisononyl phthalate (DINP) (SP value: 8.9), and diundecyl phthalate (DUP) (SP value: 8.6); adipate-based plasticizers such as di-2-ethylhexyl adipate (DOA) (SP value: 8.5), and diisononyl adipate (DINA) (SP value: 8.5); a trimellitate-based plasticizer (SP value: 9.0); a polyester adipate-based plasticizer (SP value: 9.0 to 9.4); a polyester phthalate-based plasticizer (SP value: 9.3); citrate-based plasticizers such as acetyl tributyl citrate (ATBC) (SP value: 9.0); benzoate-based plasticizers such as glycol ester benzoate (SP value: 9.9); and telephthalate-based plasticizer such as terephthalic acid bis(2-ethylhexyl) (SP value: 8.9). These plasticizers may be used singly, or two or more of these plasticizers may be used in combination as necessary.

In a case where the base material 100 includes polyvinyl chloride (SP value: 9.5), for example, an acetyl citrate-based plasticizer such as acetyl tributyl citrate (ATBC) or an adipate-based plasticizer such as di-2-ethylhexyladipate (DOA) is preferably used as the plasticizer.

The porous foam 200 is preferably impregnated with the base material 100 in the form of a sol composition including the vinyl chloride-based resin, especially polyvinyl chloride, and a plasticizer. This is because the sol composition including the vinyl chloride-based resin and the plasticizer has fluidity in impregnation and absorption in the porous foam 200 and is easily cured in gaps in the porous foam 200.

In the eraser 10, the total proportion of the resin component and the elastomer component in the base material 100 is not specifically limited. For example, 100% by mass of the base material 100 includes 10% by mass or more and 80% by mass or less, preferably 20% by mass or more and 70% by mass or less of at least one of the resin component or the elastomer component.

In the eraser 10, the proportion of the plasticizer in 100% by mass of the base material 100 is 10% by mass or more and 80% by mass or less, preferably 20% by mass or more and 70% by mass or less (where the total proportion of the resin component, the elastomer component, and the plasticizer is 100% by mass or less), for example.

A content of at least one of the resin component or the elastomer component is preferably 25.0% by mass or more and 45.0% by mass or less, and a content of the plasticizer is preferably 35.0% by mass or more and less than 55.0% by mass. In this composition, it is possible to ensure obtaining of the eraser 10 having both high elasticity and high erasability.

The base material 100 may further include a filler such as calcium carbonate, magnesium carbonate, magnesium oxide, silica, talc, clay, diatomaceous earth, ground quartz, alumina, alumina silicate, or mica.

The content of the filler in 100% by mass of the base material 100 is 0% by mass or more and 70% by mass or less, preferably 5% by mass or more and 40% by mass or less, for example.

The base material 100 may further include other additives such as a polishing agent, a metal soap, a barium-zinc-based stabilizer, a calcium-zinc-based stabilizer, a magnesium-zinc-based stabilizer, a coloring agent, a perfume, a surfactant, and glycols. Examples of the coloring agent include known pigments such as an organic pigment, an inorganic pigment, and a fluorescent pigment, and known dyes.

The base material 100 may include a fugitive pigment component composed of pressure-sensitive microcapsules to be crushed by a rubbing force (pressure-sensitive fugitive pigment component) and/or a fugitive pigment component including a heat-sensitive coloring component to be discolored by a rubbing force (heat-sensitive fugitive pigment component).

[Porous Foam]

The eraser 10 according to this embodiment includes the porous foam 200 impregnated with the base material 100. The porous foam 200 preferably has a framework organization which is impregnatable with the base material 100 and in which the framework of the porous foam 200 is separated and removed together with abrasion of the base material 100 by a friction force against a sheet surface.

Examples of the material for the porous foam 200 include: various resins including as thermosetting resins exemplified by a melamine-based resin, an epoxy-based resin, a urethane-based resin, an urea-based resin, and a phenol-based resin; thermoplastic resins exemplified by a styrene-based resin such as polystyrene, an ester-based resin such as polyester, an acrylic-based resin such as polyacrylate, an olefin-based resin such as polyethylene, and a vinyl chloride-based resin such as polyvinyl chloride; and elastomers. A natural polymer porous body such as sponge may be used, for example. The material for the porous foam 200 may further include various rubbers such as natural rubber, styrene-butadiene rubber, and nitrile-butadiene rubber, natural fibers such as cotton, silk, and hemp, and synthetic fibers such as cellulose-based fibers, ester-based fibers, acrylic-based fibers, and amide-based fibers.

Among these materials, the porous foam 200 is preferably a melamine foam made of a melamine resin from the viewpoints of high affinity for the base material 100, easy separation of organization by a friction force against a sheet surface, and an appropriate tensile elasticity.

[Method for Producing Eraser 10]

The eraser 10 according to the present invention is produced by impregnating gaps in the porous foam 200 with the base material 100 so that the base material 100 enter the gaps. The method for producing the eraser is not limited to a specific method, and a method as described below may be employed as an example.

First, materials for the base material 100 including at least one of the resin component or the elastomer component, the plasticizer, and the filler described above, and another additive, which is added as necessary, are sufficiently stirred and mixed, thereby preparing the base material 100. In the case of using, for example, a vinyl chloride resin as a resin component, a granular resin is used, for example. Additionally, a sheet-like porous foam 200 is prepared.

Next, the porous foam 200 is impregnated with the base material 100, thereby filling gaps in the porous foam 200 with the base material 100. For example, an uncured base material in an amount with which gaps in the porous foam 200 are sufficiently filled is placed with the porous foam 200 being allowed to stand so that the base material 100 is absorbed in the gaps for impregnation. The gaps may be impregnated with the base material 100 by immersing the porous foam 200 in a plate-shaped mold filled with the uncured base material 100. The porous foam 200 may be compressed by pressing in a state where gaps in the porous foam 200 are impregnated with an uncured base material 100 such that the uncured base material 100 spreads over the entire gaps of the porous foam 200. The impregnation may be performed while evacuation is performed so that the eraser 10 does not include pores, that is, the eraser 10 does not include gaps in which the base material 100 is not present. To uniformize and increase the impregnation amount of the base material 100, an uncured base material 100 is further poured, from above, into the porous foam 200 impregnated with the uncured base material 100.

The base material 100 is cured with gaps in the porous foam 200 being impregnated with the uncured base material 100. To enhance productivity, curing is preferably performed by heating. The heating is preferably performed by hot pressing because heating can be uniformly performed to a center portion of the porous foam 200. The hot pressing is performed by pressing the porous foam 200 impregnated with the base material 100 while the porous foam 200 is sandwiched between two pressing discs larger than the porous foam 200. The hot pressing may serve as both pressing for allowing the base material 100 to spread over the entire gaps in the porous foam 200 and pressing for promoting curing by heating. A pressure in pressing is appropriately set as necessary. For example, a pressing pressure in pressing a sheet of eraser can be set at 5 kgf/cm² (49 N/cm²) or more and 150 kgf/cm² (1470 N/cm²) or less.

The curing with heat is preferably performed at 100° C. or more and 160° C. or less in a heating time of 5 minutes or more and 50 minutes or less. In particular, curing at 105° C. or more and 140° C. or less in a heating time of 5 minutes or more and 20 minutes or less is preferable for production the eraser 10 having both high elasticity and high erasability. The heating is preferably performed under pressurization by pressing.

As the base material 100, a base material 100 in a sol state having a viscosity of 100 to 20,000 mPa/s (preferably 800 to 7,000 mPa s) under measuring conditions at 20° C. with a B-type viscometer at 6 rpm, especially a sol composition of a polyvinyl chloride resin, is also preferably used as an uncured base material 100. This is because the base material 100 having a viscosity in this range has a fluidity suitable for impregnating and absorbing the uncured base material 100 in the porous foam 200 at room temperature. In addition, such a base material 100 can easily fill gaps and can be easily cured while filling the gaps. Even for an uncured base material 100 having a high viscosity exceeding 20,000 mPa s, impregnation can be performed by reducing the viscosity with heat or reducing the pressure, for example.

The sheet-like eraser base material thus obtained by curing is cut into a predetermined size as necessary, thereby producing an eraser 10.

[Eraser]

The eraser 10 has a structure in which the porous foam 200 is impregnated with the base material 100. In the eraser 10, the porous foam 200 is impregnated with the base material 100 such that gaps in the porous foam 200 are filled with the base material 100. In one state of the eraser 10, the base material 100 is cured by heating, and fixed in gaps in the porous foam 200.

The eraser 10 is preferably configured such that the base material 100 is worn by rubbing in erasing and is removed from the eraser 10, and framework organization of the porous foam 200 is broken and removed by abrasion of the base material 100.

### EXAMPLES

The present invention will now be more specifically described with reference to examples. The scope of the present invention is not limited by the description of examples.

### Example 1

### (Preparation of Eraser)

An eraser according to Example 1 was prepared by using a base material having a composition described below and a porous foam described below. Measurement of a particle size described later was performed in conformity with JIS K5600-2-5; 1999, and a third sample was measured with a 100-μm glide gauge.

[Base Material]

(1) Resin: 31.0 parts by mass of polyvinyl chloride (product name “ZEST P21,” produced by SHINDAI-ICHI VINYL CORPORATION) (particle size: 55 μm, degree of polymerization: 1550, K value: 75.1, viscosity 5300 (mPa s))
(2) Plasticizer: 48.0 parts by mass of acetyl tributyl citrate (ATBC)
(3) Filler: 20.5 parts by weight of heavy calcium carbonate (product name “LIGHTON A-4,” produced by Bihoku Funka Kogyo Co., Ltd.)

### (4) Stabilizer:

(4-1) 0.4 parts by mass of a magnesium-zinc-based stabilizer (Mg/Zn composite metal soap) (product name “EMBILIZER R-23L,” produced by Tokyo Fine Chemical CO., LTD.)
(4-2) 0.1 part by mass of an organic phosphorus-based stabilizer (phosphite) (product name “EMBILIZER TC-110S,” produced by Tokyo Fine Chemical CO., LTD.)

[Porous Foam]

melamine foam (product name “Basotect (registered trademark)” (tensile elasticity of melamine foam: 0.22 MPa, density: 9.0 kg/m³), produced by BASF)

Components constituting a base material were placed in a stirring vessel and stirred to be uniform, thereby preparing a base material. Then, 0.15 parts by mass of a sheet-like melamine foam cut into a predetermined size (60 mm×23 mm×10 mm) was impregnated with 20 parts by mass of a base material. With the melamine foam being impregnated with the base material, the melamine foam was hot-pressed for 10 minutes at 120° C. under a pressing pressure of 10 kgf/cm² (=98 N/cm²) so that the base material was cured, thereby preparing an eraser.

### Example 2

Materials for a filler, a stabilizer, a porous foam used in Example 2 were the same as those in Example 1, polyvinyl chloride (product name “ZEST P22,” produced by SHINDAI-ICHI VINYL CORPORATION) (particle size: 55 μm, degree of polymerization: 1060, K value: 67.1, viscosity: 3000 (mPa s)) was used as a resin, and DOA was used as a plasticizer. A composition ratio is shown in Table 1. Except that the temperature of the hot pressing was 135° C., an eraser according to Example 2 was obtained by a preparation method similar to that of Example 1.

### Example 3

An eraser according to Example 3 was obtained by a procedure similar to that of Example 1 except for using polyvinyl chloride as a resin component having a particle size of 45 μm with the composition ratio shown in Table 2.

### Example 4

An eraser according to Example 4 was obtained by a procedure similar to that of Example 1 except for using polyvinyl chloride as a resin component having a particle size of 63 μm with the composition ratio shown in Table 2.

### Example 5

Materials for a resin, a plasticizer, a filler, a stabilizer, and a porous foam used in Example 5 were the same as those used in Example 1. The amount of the plasticizer was 34.0 parts by weight, and a composition ratio of the other materials is shown in Table 2. Except for these, an eraser according to Example 5 was obtained by a preparation method similar to that of Example 1.

### Example 6

Materials for a resin, a plasticizer, a filler, a stabilizer, and a porous foam used in Example 6 were the same as those used in Example 1. The amount of the plasticizer was 40.0 parts by weight, and a composition ratio of the other materials is shown in Table 2. Except for these, an eraser according to Example 6 was obtained by a preparation method similar to that of Example 1.

### Example 7

Materials for a resin, a plasticizer, a filler, a stabilizer, and a porous foam used in Example 7 were the same as those used in Example 1. The amount of the plasticizer was 46.0 parts by weight, and a composition ratio of the other materials is shown in Table 2. Except for these, an eraser according to Example 7 was obtained by a preparation method similar to that of Example 1.

### Example 8

Materials for a resin, a plasticizer, a filler, a stabilizer, and a porous foam used in Example 8 were the same as those used in Example 1. The amount of the plasticizer was 50.0 parts by weight, and a composition ratio of the other materials is shown in Table 2. Except for these, an eraser according to Example 8 was obtained by a preparation method similar to that of Example 1.

### Example 9

Materials for a resin, a plasticizer, a filler, a stabilizer, and a porous foam used in Example 9 were the same as those used in Example 2. The amount of the plasticizer was 40.0 parts by weight, and a composition ratio of the other materials is shown in Table 3. Except for these, an eraser according to Example 9 was obtained by a preparation method similar to that of Example 1.

### Example 10

Materials for a resin, a plasticizer, a filler, a stabilizer, and a porous foam used in Example 10 were the same as those used in Example 2. The amount of the plasticizer was 48.0 parts by weight, and a composition ratio of the other materials is shown in Table 3. Except for these, an eraser according to Example 10 was obtained by a preparation method similar to that of Example 1.

### Example 11

Materials for a plasticizer, a filler, a stabilizer, and a porous foam used in Example 11 were the same as those used in Example 2. Polyvinyl chloride (product name “ZEST P21,” produced by SHINDAI-ICHI VINYL CORPORATION) (average particle size: 55 degree of polymerization: 1550, K value: 75.1, viscosity: 5300 (mPa s)) was used as a resin, and a composition ratio of other materials is shown in Table 3. Except for these, an eraser according to Example 11 was obtained by a preparation method similar to that of Example 1.

### Example 12

Materials for a resin, a filler, a stabilizer, and a porous foam used in Example 12 were the same as those used in Example 1. Two types of the plasticizer, ATBC and DOA, were used. The amount of ATBC was 23.0 parts by mass, the amount of DOA was 23.0 parts by mass, and a composition ratio of the other materials is shown in Table 3. Except for these, an eraser according to Example 12 was obtained by a preparation method similar to that of Example 1.

### Comparative Example 1

An eraser according to Comparative Example 1 was obtained by a preparation method similar to that of Example 1 except for not using a porous foam while using the same resin, plasticizer, filler, and stabilizer as those in Example 1.

### Comparative Example 2

An eraser according to Comparative Example 2 was obtained by a preparation method similar to that of Example 2 except for not using a porous foam while using the same resin, plasticizer, filler, and stabilizer as those in Example 2.

[Measurement of Physical Properties and Evaluation of Characteristics]

Physical properties of an eraser were measured by a procedure described below, and characteristics thereof were evaluated.

[Tensile Elasticity]

An eraser 10 was punched into a dumbbell shape having a gauge length of 30 mm, thereby preparing a test piece for a tensile test. The prepared test piece was used for measurement of a tensile elasticity (MPa) by a method in conformity with JIS K 6251.

[Evaluation of Eraser Characteristics]

Next, characteristics as a typical eraser were evaluated. As a characteristic, an erasability (%) was evaluated. The evaluation was conducted in the following procedure:

[Erasability]

The erasability was measured by the following procedure in conformity with JSI S 6050: 2002 6.4.

(1) An eraser was cut into a plate shape with a thickness of 5 mm, and a tip portion of the eraser that is to contact with a colored paper sheet is finished into an arc shape having a radius of 6 mm.

(2) A colored paper sheet was prepared with a line machine by using an HB pencil defined by JIS S 6006 and a wood free paper sheet having a basis weight of 90 g/m² or more and a degree of whiteness of 75% or more. A test piece was brought into contact with the colored paper sheet such that the test piece was perpendicular to the colored paper sheet and at a right angle with respect to a colored line. In this state, a weight was placed on the test piece such that the sum of masses of the weight and the holder was 0.5 kg, and a colored portion was reciprocated four times at a speed of 150±10 cm/min. to be rubbed off.

(3) A density of each of the colored portion and the rubbed-off portion was measured with a densitometer with a density of a non-colored portion of the colored paper sheet being defined at zero.

(4) An erasability was calculated by the equation below, and a mean value of three calculations was obtained.

erasability (%)=(1−(rubbed-off portion density)÷(colored portion density))×100

TABLE 1

| | | | | Compar- | Compar- |
|---|---|---|---|---|---|
| | | | | ative | ative |
| | | Exam- | Exam- | Exam- | Exam- |
| | | ple 1 | ple 2 | ple 1 | ple 2 |
| resin | polyvinyl | 31.0 | 33.0 | 31.0 | 33.0 |
| component | chloride | | | | |
| plasticizer | ATBC | 48.0 | — | 48.0 | — |
| | DOA | — | 43.0 | — | 43.0 |
| stabilizer | Mg/Zn | 0.4 | 0.5 | 0.5 | 0.5 |
| | composite | | | | |
| | metal soap, | | | | |
| | etc. | | | | |
| | phosphite | 0.1 | 0.3 | 0.1 | 0.3 |
| filler | heavy | 20.5 | 23.2 | 20.5 | 23.2 |
| | calcium | | | | |
| | carbonate | | | | |
| porous foam | | present | present | absent | absent |
| erasability | | 94.5 | 93.6 | 93.6 | 92.5 |
| (%) | | | | | |
| tensile | | 0.83 | 0.84 | 0.54 | 0.39 |
| elasticity | | | | | |
| (MPa) | | | | | |

TABLE 2

| | | Example 3 | Example 4 | Example 5 | Example 6 | Example 7 | Example 8 |
|---|---|---|---|---|---|---|---|
| resin | polyvinyl | 31.0 | 31.0 | 40.0 | 36.0 | 32.0 | 30.0 |
| component | chloride | | | | | | |
| plasticizer | ATBC | 48.0 | 48.0 | 34.0 | 40.0 | 46.0 | 50.0 |
| | DOA | — | — | — | — | — | — |
| stabilizer | Mg/Zn composite | 0.4 | 0.4 | 0.5 | 0.5 | 0.4 | 0.4 |
| | metal soap, etc. | | | | | | |
| | phosphite | 0.1 | 0.1 | 0.1 | 0.1 | 0.1 | 0.1 |
| filler | heavy calcium | 20.5 | 20.5 | 25.4 | 23.4 | 20.5 | 19.5 |
| | carbonate | | | | | | |
| porous foam | | present | present | present | present | present | present |
| erasability (%) | | 94.1 | 94.7 | 81.1 | 90.8 | 94.7 | 94.9 |
| tensile elasticity | | 0.72 | 0.86 | 1.59 | 0.99 | 0.82 | 0.60 |
| (MPa) | | | | | | | |

TABLE 3

| | | Exam- | Exam- | Exam | Exam- |
|---|---|---|---|---|---|
| | | ple 9 | ple 10 | ple 11 | ple 12 |
| resin | polyvinyl | 36.0 | 31.0 | 32.0 | 32.0 |
| component | chloride | | | | |
| plasticizer | ATBC | — | — | — | 23.0 |
| | DOA | 40.0 | 48.0 | 46.0 | 23.0 |
| stabilizer | Mg/Zn | 0.5 | 0.4 | 0.4 | 0.4 |
| | composite | | | | |
| | metal soap, | | | | |
| | etc. | | | | |
| | phosphite | 0.1 | 0.1 | 0.1 | 0.1 |
| filler | heavy | 23.4 | 20.5 | 21.5 | 21.5 |
| | calcium | | | | |
| | carbonate | | | | |
| porous foam | | present | present | present | present |
| erasability | | 89.6 | 94.8 | 94.1 | 94.2 |
| (%) | | | | | |
| tensile | | 1.04 | 0.60 | 0.84 | 0.62 |
| elasticity | | | | | |
| (MPa) | | | | | |

(Results)

Example 1, Example 2, Example 3, Example 4, Example 5, Example 6, Example 7, Example 8, Example 9, Example 10, Example 11, and Example 12 are examples of erasers belonging to the scope of the present invention. Comparative Example 1 and Comparative Example 2 are examples of erasers not belonging to the scope of the present invention. Specifically, Comparative Example 1 and Comparative Example 2 correspond to Example 1 and Example 2, respectively, and are examples in which a structure of each eraser includes no porous foam.

With reference to Example 1 through Example 12, tensile elasticities of Example 1, Example 2, Example 4, Example 5, Example 6, Example 7, Example 9, and Example 11 are 0.80 MPa or more, and tensile elasticities of Example 1, Example 2, Example 4, Example 5, Example 6, Example 9, and Example 11 are 0.83 MPa or more, and are so-called high strengths. Tensile elasticities of Example 3, Example 8, Example 10, and Example 12 are also 0.60 MPa or more, which means these examples have sufficient strengths. Example 1, Example 2, Example 3, Example 4, Example 6, Example 7, Example 8, Example 10, Example 11, and Example 12 also have high erasabilities of 90% or more. Example 5 and Example 9 also have sufficiently high erasabilities of 80% or more.

On the other hand, with respect to Comparative Example 1 and Comparative Example 2, although erasabilities thereof exceed 90%, because of the absence of a porous foam, tensile elasticities are as low as 0.60 MPa or less, and specifically 0.55 MPa or less.

As described above, an eraser according to the present invention has high elasticity and high erasability.

In Example 1, Example 3, and Example 4, the particle size of polyvinyl chloride are varied. All of these examples have excellent evaluation results. Here, if polyvinyl chloride has an excessively large particle size, for example, larger than 100 an obtained eraser tends to have a low gel hardness. As characteristics of the obtained eraser, the eraser is soft and tends to be greatly broken in use. In addition, granular clusters appear on the surface of the obtained eraser, which causes tendency of unfavorable appearance. On the other hand, if polyvinyl chloride has an excessively small particle size, for example, smaller than 20 μm, the obtained eraser tends to have a high gel hardness. As characteristics of the obtained eraser, the eraser is hard and tends to be broken into powder in use. In addition, waste debris after use is very fine, and tends to contaminate surrounding environments. Furthermore, the surface of the eraser after use tends to be contaminated. Thus, the particle size of polyvinyl chloride is preferably 20 μm or more and 100 μm or less. In this case, the eraser can be easily produced in a preferable state. By setting the particle size of the polyvinyl chloride at 45 μm or more and 63 μm or less as shown in Example 1, Example 3, and Example 4, it is possible to ensure production of the eraser with a preferable state.

In addition, with respect to the porous foam, if the porous foam is very soft and coarse, that is, includes large gaps, the effect of impregnation utilizing a capillary action in production cannot be sufficiently obtained. Thus, the inside of the porous foam tends to be less likely to be impregnated with a melted resin component. Further, as characteristics of the obtained eraser, the eraser does not have so-called resilience, and tends to be easily bent. Furthermore, in use, the eraser is not finely broken by abrasion and tends to be roughly broken. Moreover, gaps tend to be easily formed in the obtained eraser. On the other hand, if the porous foam is very hard and has high density, that is, includes very small gaps, inside the porous foam tends to be less likely to be impregnated with the melted resin component in production. In addition, the amount of abrasion of the obtained eraser is small in use so that a new surface does not easily appear, and erasability tends to be poor. Thus, the density of the porous foam is preferably 3.5 kg/m³ or more and 12.0 kg/m³ or less, for example. In this case, a preferable state can be obtained in production and in use.

It should be understood that the embodiments disclosed here are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

An eraser according to the present invention is advantageously used especially in a case where high elasticity and high erasability are required.

### DESCRIPTION OF REFERENCE NUMERALS

10 eraser, 20 cover, 100 base material, 200 porous foam.

1. An eraser comprising:
a base material including a plasticizer and at least one of a resin component or an elastomer component; and
a porous foam made of a resin and impregnated with the base material, wherein
the plasticizer has an SP value of 8.3 or more and 10 or less.

2. The eraser according to claim 1, wherein the porous foam is a melamine foam.

3. The eraser according to claim 1, wherein the plasticizer includes at least one of acetyl tributyl citrate (ATBC) or di-2-ethylhexyladipate (DOA).

4. The eraser according to claim 1, wherein
the base material includes a polyvinyl chloride resin as the resin component, the plasticizer, a filler, and a stabilizer, and
the plasticizer consists of ATBC.

5. The eraser according to claim 1, wherein
the base material includes a polyvinyl chloride resin as the resin component, the plasticizer, a filler, and a stabilizer, and
the plasticizer consists of DOA.

6. The eraser according to claim 1, wherein
a content of at least one of the resin component or the elastomer component is 25.0% by mass or more and 45.0% by mass or less, and
a content of the plasticizer is 35.0% by mass or more and less than 55.0% by mass.

7. The eraser according to claim 1, wherein the porous foam has a tensile elasticity of 0.05 MPa or more and 0.4 MPa or less.

8. The eraser according to claim 1, wherein the porous foam has a density of 3.5 kg/m³ or more and 12.0 kg/m³ or less.
